(19) United States
(12) Patent Application Publication
(10) Pub. No.: US 2004/0055205 A1
(43) Pub. Date: Mar. 25, 2004

(54) Fishing jig and method of making a fishing jig

(76) Inventor: Mark Pack, Mineola, TX (US)

Correspondence Address: VENABLE, BAETJER, HOWARD AND CIVILETTI, LLP, P.O. BOX 34385, WASHINGTON, DC, 20043-9998, US

(21) Appl. No.: 10/251,829

(22) Filed: Sep. 23, 2002

(51) Int. Cl. A01K 85/00

(52) U.S. Cl. 43/42.53

(57) ABSTRACT

A method for producing a fishing jig includes placing a composition of metal powder into a die. The composition is compressed within the die to form a jig head in one piece. The jig head is removed from the die and heated to form the fishing jig. A weed guard and hook are affixed into a slot in the jig head by filling the slot with at least one of tin, bismuth and lead.

### BACKGROUND OF THE INVENTION

1. Field of the Invention

The present invention relates generally to a fishing lure and a method of manufacturing a fishing lure, more specifically, a fishing jig.

2. Related Art

It has long been understood that the use of fishing lures to attract fish is a preferred method of fishing for sportsmen and other small-time fishermen. One of the more popular types of lures is the jig. As further defined below, the term “fishing jig” pertains to a particular type of fishing lure having a head or bead and a hook protruding therefrom. An eyelet extends from the jig for securing the jig to the fishing line. In known prior art fishing jigs, the head generally comprises a lead bead.

Conventionally, jigs are formed by casting a molten metal to form the jig head. However, this results in a jig head that is very brittle in the casted state. Furthermore, this method makes it difficult to form a jig head with a composite metal because some metals are insoluble with one another even in the liquid state.

Jigs can also be formed by forging or machining. However, this is an expensive and inexact process.

As discussed above, a common material used to construct fishing jigs is lead. One significant drawback to the use of lead fishing jigs is that they are not environmentally safe.

### SUMMARY OF THE INVENTION

In an exemplary embodiment of the present invention, a fishing jig and a method for manufacturing fishing jigs are disclosed.

The present invention includes a fishing jig manufactured by compressing a composition of metal powder in a die to form a jig head. The jig head is removed from the die and heated. Usually, a slot is formed in the jig head before heating. After heating, a weed guard and hook is placed into the slot in the jig head. The weed guard and hook are affixed into the slot of the jig head by filling the slot with at least one of tin, bismuth and lead.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 shows the fishing jig formed in accordance with the present invention.

FIG. 2 is a flow chart of one method that may be used to produce a fishing jig according to the present invention.

FIG. 3 depicts a table showing the chemical components of an exemplary embodiment of the jig head according to the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without departing from the spirit and scope of the invention.

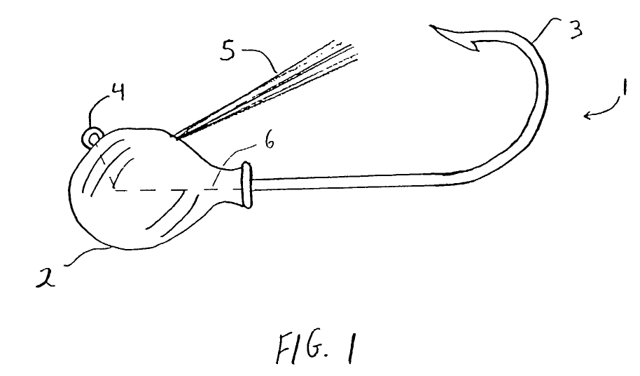

FIG. 1 shows an exemplary fishing jig 1 manufactured according to the present invention, although the fishing jigs of the present invention may be configured to have a wide variety of sizes and shapes. The fishing jig 1 is comprised of a jig head 2, a hook 3 attached to the jig head 2, an eyelet 4 for attaching the jig 1 to a fishing line (not shown) and a weed guard 5. In the preferred embodiment, the eyelet 4 is on the end of the hook 3. Reference numeral 6 shows the approximate position of a slot in the jib head 2 for arranging the hook 3 and weed guard 5. As can be seen from FIG. 1, the exemplary jig head 2 is generally oval in shape.

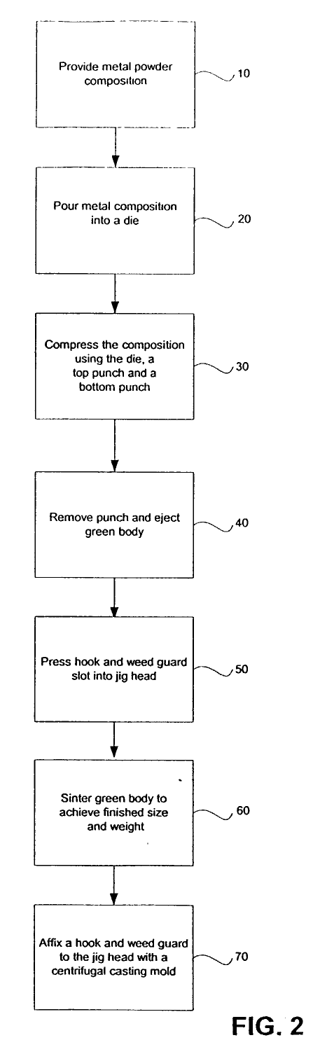

FIG. 2 depicts a flow chart for manufacturing the fishing jig in accordance with the present invention.

To form the head of the jig, powdered metallurgy principles are used. As shown in step 10, a composition of metal powder or powders is selected and mixed. Optionally, a lubricant or binder can also be added to the composition. In step 20, the composition is loaded into a die or mold. Preferably, the die has a top punch and a bottom punch. In step 30, the jig head is pressed in one piece using the die, top punch and bottom punch. A hook and weed guard slot is also formed in step 30. The pressure of the die in step 30 compacts the powdered metal to impart sufficient cohesion that enables the jig head to be handled without damage to the jig head. In step 40, the top and bottom punches are removed and the jig head is ejected. At this point, the jig head is in the “green” state and must be sintered to achieve the finished size and weight.

In step 50, the green jig head is heated, usually in a protective atmosphere, at a temperature below the melting point of the primary constituent of the composition so that the powder particles weld together and confer sufficient strength to function as a jig head. Typical temperatures used during the sintering process can be between 60% and 90% of the melting point of the particular metal or alloy. For some powder mixtures, however, the sintering temperature may be above the melting-point of the lower-melting constituent so that sintering may actually take place in the presence of a liquid phase. In the preferred embodiment, the temperature during sintering reaches 1450-1500° C. and the dwell time of the process is about one hour. Other suitable temperatures and dwell times can be utilized.

Optionally, after sintering, the jig head can be tumbled or washed in an abrasive slurry to remove any sharp edges.

In step 60, the hook and weed guard are placed into the jig head. The jig head is then placed into a two piece centrifugal casting mold wherein the hook and weed guard are fixed to the jig head by filling the hook and weed guard slot with either tin, bismuth, lead, or a combination thereof.

Subsequent to step 60, the jig head can go through further finishing steps, for example, coating the jig head with powdered paint and installing a skirt.

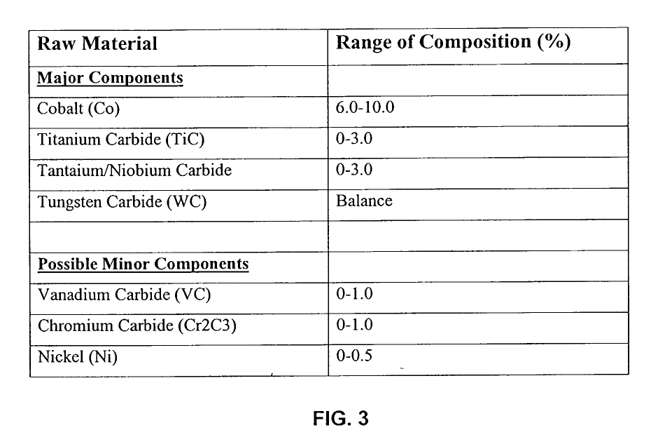

The chemical composition of the jig head of the preferred embodiment is shown in the table of FIG. 3.

As can be seen from FIG. 3, most of the jig head is composed of tungsten carbide. The powdered composition used to form the jig head includes 81.5 wt. percent to about 94 wt. percent tungsten carbide powder. Approximately 6 wt. percent to about 10 wt. percent of the jig head is cobalt. Titanium carbide, tantalum/niobium carbide, vanadium carbide, chromium carbide and nickel an also be used, depending on the desired characteristics of the jig head.

The method of producing fishing jigs results in a much cheaper production process than conventional methods.

The tungsten carbide fishing jigs of the present invention provide a number of significant advantages over the conventional lead fishing jigs. For example, the tungsten fishing jigs of the present invention may be configured to be about 25% smaller than a lead weight of similar weight. A smaller sized jig head enhances the fish hooking capability of the jig head. As another example, when the tungsten fishing jigs of the invention strike an object in water, they produce a sound which is approximately twice as loud as lead. Such a feature helps attract fish. Another important advantage is that tungsten jigs are environmentally safe and do not pose significant health hazards to wildlife.

A further advantage of the present invention is that the jig head can be formed in one piece, instead of the two pieces used to form conventional jig heads.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for producing a fishing jig, comprising:
placing a composition of metal powder into a die;
compressing the composition within the die to form a green body;
removing the green body from the die; and
heating the green body to form the fishing jig.

2. The method of claim 1, wherein the compressing step includes compressing the composition such that a slot is formed in the green body.

3. The method of claim 2, further comprising affixing a weed guard and hook into the slot after the heating step.

4. The method of claim 3, wherein the affixing step includes filling the slot with at least one of tin, bismuth and lead.

5. The method of claim 1, wherein the composition comprises about 81.5 wt. percent to about 94 wt. percent tungsten carbide powder.

6. The method of claim 1, wherein the composition comprises about 6 wt. percent to about 10 wt. percent cobalt powder.

7. The method of claim 1, wherein the fishing jig has a jig head and the compressing step includes forming the jig head in one piece.

8. The method of claim 1, further comprising tumbling the fishing jig in an abrasive slurry after being removed from the die.

9. A fishing jig produced according to the steps of:
placing a composition of metal powder into a die;
compressing the composition with the die to form a green body with a slot;
removing the green body from the die;
heating the green body; and
affixing a weed guard and hook into the slot.

10. The fishing jig of claim 9, wherein the compressing step forms a jig head in one piece.

11. A fishing jig comprising:
a jig head being constructed in one piece from a composition comprising a tungsten carbide powder and defining a slot; and
a hook and weed guard being affixed in the slot of the jig head.

12. The fishing jig of claim 11, further comprising at least one of tin, bismuth and lead for filling the slot and affixing the hook and weed guard in the slot.
